(19) United States
(12) Patent Application Publication
(10) Pub. No.: US 2016/0137539 A1
(43) Pub. Date: May 19, 2016

(54) SEWAGE TREATMENT SYSTEM AND METHOD THEREOF

(71) Applicant: NANJING DELEI SCIENCE & TECHNOLOGY CO., LTD., Jiangsu (CN)

(72) Inventor: Hao Wu, Nanjing (CN)

(73) Assignee: NANJING DELEI SCIENCE & TECHNOLOGY CO., LTD., Nanjing (CN)

(21) Appl. No.: 14/899,354

(22) PCT Filed: Jun. 16, 2014
(86) PCT No.: PCT/CN2014/079909

§ 371 Date: Dec. 17, 2015

(30) Foreign Application Priority Data
Jun. 17, 2013 (CN) 201310238756.5
Apr. 16, 2014 (CN) 201410154047.3
Jun. 10, 2014 (CN) 201410254417.0
Jun. 10, 2014 (CN) 201410254495.0
Jun. 10, 2014 (CN) 201410255026.0
Jun. 10, 2014 (CN) 201410255792.7

(51) Int. Cl. C02F 9/00; C02F 3/10; C02F 1/00; C02F 1/72; C02F 1/78

(52) U.S. Cl. CPC C02F 9/00; C02F 1/725; C02F 1/78; C02F 1/004; C02F 3/10; C02F 2201/782

(57) ABSTRACT

A sewage treatment system includes a sewage pump, an inclined-plate catalytic reaction tower, a first centrifugal pump, a first jet device, a first oxygenator, a first ozonizer, a first catalytic reactor, a first heat exchanger, a filler catalytic tower, an aeration biological tower, and a water storage tank; the outlet of the sewage pump connects with the first inlet of the inclined-plate catalytic reaction tower; the first outlet of the inclined-plate catalytic reaction tower connects with the inlet of the first centrifugal pump; the outlet of the first centrifugal pump connects with the first inlet of the first jet device; the outlet of the first oxygenator connects with the inlet of the first ozonizer; the outlet of the first ozonizer connects with the second inlet of the first jet device; and the outlet of the first jet device connects with the inlet of the first catalytic reactor.

### BACKGROUND OF THE INVENTION

1. Technical Field

The present invention relates to the technical field of sludge treatment, and more especially, to a wastewater treatment system and the method thereof.

2. Description of Related Art

With the rapid advance of the industrialization and the growth of the population, water pollution is worsening dramatically, exacerbating the shortage of already scarce freshwater resources that are being made unavailable to people. According to recent statistics, there are over two thousand kinds of water-borne contaminants, mainly organic matter, carbides, heavy metals and pathogenic microorganisms. For example, the Hai River, Huai River and Liao River in North China, are black and stinky, looking like large drainage ditches. In South China, Tai Lake, Chao Lake and Tien Lake suffer from severe eutrophication due to collection of large quantity of organic-polluted water, thereby often losing their utility values due to algae outbreak. At present, the annual sewage discharge in China is about 30 billion tons, 70%-80% of which is discharged without any pretreatment. Thus, China has a capacity to treat only around 20% of polluted water. Water pollution is still worsening, spreading from tributaries to main streams, from cities to countrysides, from earth surface to underground, and from land to sea.

The troublesome wastewaters, such as chemical wastewater, petrochemical wastewater, coking wastewater, garbage dump seepage, pharmaceutical wastewater, cyanide-containing electroplating wastewater and grinding wastewater, contain a large amount of biologically toxic matters and organic matters, which are very difficult to biodegrade. The organic matters contain complex constituents and have high COD (chemical oxygen demand). Therefore, the aforementioned wastewaters are very difficult to treat. Environmentalists have been working hard to explore methods for treating heavily polluted industrial wastewaters that are difficult to treat. Currently, the UV-catalyzed oxidation process is the most commonly investigated, wherein a vacuum UV generator is used to emit high-intensity ultraviolet rays. The high-energy photons, through direct photolysis, break the chemical bonds of organic matters in wastewaters and mineralize them. At the same time, the high-energy photons can also sensitize difficult-to-degrade organic matters to convert them into unstable sensitized states conducive to further degradation. Then, the organic matters are catalytically oxidized under the action of catalysts and hydrogen peroxide. At the same time, ultraviolet light, catalysts and oxidants are introduced to produce synergistic effects, generating free radicals of hydroxyl, oxygen ions and the like, which can decompose organic pollutants in highly-concentrated wastewater into CO₂, water and other harmless constituents, while deodorizing, decolorizing, sterilizing and disinfecting the wastewater. This process can be used to attack various organic pollutants and microorganisms in wastewater until they are degraded into CO₂, H₂O and inorganic salts. However, many such wastewater treatment systems have stringent requirements for reaction conditions, are costly, and the treatment effects are unpredictable.

At present, the available methods for troublesome wastewater treatment include the Fenton process, the catalytic ozone oxidation process, the microwave process, the electrolytic catalysis process, the incineration process, the activated sludge process, the membrane treatment process, and other biological methods. The Fenton process, typically used in research and experiments, is a wastewater treatment method that involves chemical oxidation under acidic conditions with hydrogen peroxide (H₂O₂) as an oxidant and ferrous ions (Fe²⁺) as a catalyst. The system composed of ferrous ions and hydrogen peroxide, which are also called Fenton's reagent, can generate hydroxyl free radicals with strong oxidizing property. In an aqueous solution, the system reacts with difficult-to-degrade organic matters to generate organic free radicals to destroy their structure and finally decompose them. In addition, Fe(OH)₃ generated in the reaction can remove certain water-borne organic matters by flocculation and absorption. However, the Fenton process has some drawbacks, such as occupying a large area, involving complicated chemical feeding and pipe connections, requiring demanding reaction conditions, requiring high chemical consumption and costs, requiring unavoidable pH adjustment and precipitation after the reaction, generating a large volume of sludge and hazardous wastes, requiring stringent chemical dosing proportion during operation, and having unpredictable treatment effects, that restrict the industrialization and large-scale application of Fenton process.

The ozone-based advanced oxidation wastewater remediation process, which is a special chemical remediation technique, refers to a process, in which ozone decomposes to generate hydroxyl free radicals •OH and a series of •OH chain reactions induced by hydroxyl free radicals that oxidize a variety of water-borne organic pollutants and difficult-to-degrade polymeric organic substances from microorganisms into small molecular substances of low or no toxicity, under conditions of high temperature, high pressure and in the presence of electricity, sound, light radiation and catalysts. The wastewater control equipment of ozone oxidation is mainly based on the catalytic oxidation techniques, and consists of an ozone generation apparatus, an ozone oxidation reactor for wastewater treatment, and other apparatus that are connect in series based on the treatment processes to form integrated wastewater treatment equipment. The current ozone oxidation treatment processes have low ozone utilization efficiencies, and therefore there is a high probability of residual ozone remaining, leading to secondary pollution in the environment. In addition, the high cost and low-flow treatment of such processes render them not suitable for large-scale applications.

Therefore, it is an urgent issue in environmental protection to find a high-efficiency wastewater treatment system and the method that would not cause secondary pollutions.

### SUMMARY OF THE INVENTION

An object of the present invention is to provide a wastewater treatment system using the ozone catalytic oxidation process that would not cause secondary pollutions and methods thereof.

To solve the technical problem above, the present invention provides the following technical solutions: A wastewater treatment system, comprising a wastewater pump, a tilted-plate catalytic tower, a first centrifugal pump, a first injector, a first oxygen generator, an ozone generator, a first catalytic reactor, a first heat exchanger, a packed catalytic tower, an aeration biological tower, and a water storage tank;

Wherein the wastewater pump, the tilted-plate catalytic tower, the first injector, the first oxygen generator, the first catalytic reactor, the first heat exchanger, the packed catalytic tower, the aeration biological tower and the water storage tank are all provided with inlets and outlets;

Wherein the outlet of the wastewater pump is connected with the first inlet of the tilted-plate catalytic tower by a pipe; the first outlet of the tilted-plate catalytic tower is connected with the inlet of the first centrifugal pump by a pipe; the outlet of the first centrifugal pump is connected with the first inlet of the first injector by a pipe;

Wherein the outlet of the first oxygen generator is connected with the inlet of the first ozone generator by a pipe; the output of the first ozone generator is connected with the second inlet of the first injector by a pipe; the outlet of the first injector is connected with the inlet of the first catalytic reactor by a pipe; the outlet of the first catalytic reactor is connected with the inlet of the first heat exchanger by a pipe; the outlet of the first heat exchanger is connected with the second inlet of the tilted-plate catalytic tower by a pipe, the second outlet of the tilted-plate catalytic tower is connected with the inlet of the packed catalytic tower by a pipe, the outlet of the packed catalytic tower is connected with the first inlet of the aeration biological tower by a pipe, and the outlet of the aeration biological tower is connected with the inlet of the water storage tank by a Pipe.

Further, the outlet of the water storage tank is provided with a sampling opening: the first oxygen generator is a first molecular-sieve oxygen generator; and the first injector is a first Venturi mixer.

The wastewater treatment system also comprises a cooling system that comprises a cooling water tank, a first circulating pump, a first heat exchanger, and a first ozone generator connected in turns by a pipe to form a cooling water circulating loop. The side of the first heat exchanger that contacts wastewater is applied with a catalyst coating for speeding up the catalytic oxidation of wastewater.

The wastewater treatment system also comprises an air blower, and the second inlet of the aeration biological tower is connected with the outlet of the air blower by a pipe. The wastewater treatment system also comprises a bouncer for changing the direction of the incoming ozone-containing water and enlarging the area of the same and a filter.

The first outlet of the tilted-plate catalytic tower is provided with a filter, and the bouncer is arranged between the first ozone generator and the first Venturi mixer. The ozone intake of the first Venturi mixer is regulated by the flow of the first centrifugal pump and the valve on the pipe.

The wastewater pump is a submersible pump or a centrifugal wastewater pump. The pipe for connecting the wastewater pump and the tilted-plate catalytic tower is provided with a pressure controller and a flow controller.

Further, the first oxygen generator is provided with an air compressor, and the second inlet of the aeration biological tower is connected with the second outlet of the first oxygen generator by a pipe. The first outlet of the first oxygen generator is connected with the inlet of the first ozone generator by a pipe. An aeration network and an aeration tray are provided at the second inlet of the aeration biological tower, and a porous packing is provided in the aeration biological tower. Particle packing of inert noble metal powders are provided in the packed catalytic tower, and the specific surface area of the particle packing is 0.1-100 m²/g. Multiple layers of tilted folded-plates are provided in the aeration biological tower, and the projections of the folded plates overlap. The included angle between each layer of the folded plates and the central axis of the tower body is 30-89°.

Furthermore, the first heat exchanger is a plate-type heat exchanger or a shell-and-tube heat exchanger. The projection length of the folded plates of the aeration biological tower exceeds the length of the central axis of the tower body by 5-500 mm. The retention time of the mixture in the wastewater treatment system is longer than 10 s. The wastewater pump, the tilted-plate catalytic tower, the first centrifugal pump, the first Venturi mixer, the first oxygen generator, the first ozone generator, the second catalytic reactor, the first heat exchanger, the packed catalytic tower, the aeration biological tower, the air compressor, and the water storage tank are installed together in a first enclosure, and one or more first enclosure is provided and connected in series by a pipe.

A wastewater treatment method applied in the wastewater treatment system according to the present invention includes the following steps:

(1) performing pretreatment, absorption and precipitation of the wastewater; then allowing the wastewater to enter the tilted-plate catalytic tower, which has a function of divergence through the wastewater pump. Some wastewater enters the first centrifugal pump from the first outlet of the tilted-plate catalytic tower, and the rest remains in the tilted-plate catalytic tower after divergence by the tilted-plate catalytic tower;

(2) transporting the wastewater to the first Venturi mixer through the pump at a certain speed, and the first Venturi mixer produces negative pressure to take in ozone produced by the first ozone generator and form a mixture of ozone and wastewater;

(3) after mixing in the first Venturi mixer, introducing the mixture into the second catalytic reactor through pipes, allowing the mixture to fully contact the catalyst coating in the second catalytic reactor to undergo an oxidation-reduction reaction under the catalysis of the catalyst;

(4) introducing the product of the oxidation-reduction reaction into the tilted-plate catalytic tower though the first heat exchanger, and the ozone and the oxygen remaining in the reaction mixes with the wastewater that does not enter the second catalytic reactor;

(5) introducing the reaction product into the packed catalytic tower through the second outlet of the tilted-plate catalytic power, and the remaining ozone and oxygen undergo a full oxidation-reduction reaction with the wastewater;

(6) introducing the reaction product into the aeration biological tower through the outlet of the packed catalytic tower. After treatment by the aeration biological tower, the water flows into the water storage tank which is provided with a sampling opening at the outlet for the purpose of sampling and testing at the outlet.

The tilted-plate catalytic tower of the wastewater treatment system according to the present invention comprises first feet, and the body of a tilted-plate catalytic tower is provided on the first feet. The body of the tilted-plate catalytic tower comprises a first tower bottom, and a first packing layer and a first tower top from bottom to top. The first tower bottom has an end cover of the first tower bottom at the bottom and has an ozone-containing water inlet and a wastewater inlet on the side walls. The end cover of the tower bottom is attached with a first emptying valve. The packing layer is filled with solid packing of catalysts. The first tower top is provided with an end cover of the first tower top and is provided with a wastewater outlet at its one side wall. A divergence wastewater outlet is provided below the wastewater inlet on the side wall of the first tower bottom.

Furthermore, the divergence wastewater outlet is provided with a filter mesh made of stainless steel. The end of the L-shaped wastewater inlet is connected with a trumpet mouth facing downward and opposite the filter. The end covers of the first tower bottom and the first tower top are arc-shaped. The body of the tilted-plate catalytic tower is made of stainless steel. The L-shaped ozone-containing water inlet is provided with a bouncer. Packing support plates are provided in the first packing layer, and solid packings, which are folded plates or tilted plates with rough surfaces, are loaded on the support plates. The surfaces are applied with an inert noble metal catalyst. The angle between the folded plates or tilted-plates is 80-90°. The packing layer is filled with the solid packings, which are arranged in multiple layers. The wastewater outlet is connected with a T-adaptor and provided with a sampling opening.

A packed catalytic tower of the wastewater treatment system according to the present invention comprises a second feet, and the body of a packed catalytic tower is provided on the second feet. The body of the packed catalytic tower comprises a water incoming segment, a supporting layer, a second packing layer, and a clean-water outgoing segment from the bottom to the top. The water incoming segment comprises a second tower bottom, and the second tower bottom has an end cover of the second tower bottom at the bottom. The end cover of the tower bottom is attached with a second emptying valve. The second packing layer is filled with packings and has a first water outlet on the upper end of one side wall. Folded plates are provided in the second packing layer, and one end of the folded plates are attached to the inner wall of the second packing layer, while the other end tilts downward. The clean-water outgoing segment comprises a second tower top, which has an end cover of the second tower top, and the end cover is provided with a packing filling opening.

Further, the body of the packed catalytic tower is made of stainless steel. The end covers of the first tower bottom and the first tower top are arc-shaped. The supporting layer is a round plate, which is evenly arranged with round holes or square holes with a diameter or side length of 4-10 mm and is made of stainless steel. The packings in the second packing layer are porous particle packings with a particle size of greater than 10 mm, and their surfaces are applied with an inert noble metal catalyst. Multiple layers of folded plates are alternately arranged in the second packing layer. The projections of the folded plates in the horizontal plane overlap, and the projection length of each layer of the folded plates in the horizontal plane exceeds the length of the central axis of the tower body by 5-500 mm. The angle between each layer of the folded plates and the central axis of the tower body is 30-89°. The first water outlet is connected with a T-adaptor and provided with a sampling opening. The first water outlet is connected with a backwash pump.

A wastewater treatment system according to the present invention comprises a pump, a filtering mixer, a second injector, an ozone generating unit, a reactor, a second heat exchanger, and a revolving mixer.

The filtering mixer, the second injector, the ozone generating unit, the second reactor, the second heat exchanger, and the revolving mixer are all provided with inlets and outlets. The first outlet of the pump is connected with the first inlet of the filtering mixer by a pipe. The first outlet of the filtering mixer is connected with the first inlet of the second injector by a pipe.

The first outlet of the ozone generating unit is connected with the second inlet of the second injector by a pipe. The outlet of the second injector is connected with the inlet of the reactor by a pipe. The outlet of the reactor is connected with the first inlet of the second heat exchanger by a pipe. The first outlet of the second heat exchanger is connected with the second inlet of the filtering mixer by a pipe, and the second outlet of the filtering mixer is connected with the inlet of the revolving mixer by a pipe.

Further, the pump is a submersible pump. The wastewater treatment system also comprises a second centrifugal pump arranged between the filtering mixer and the second injector. The second centrifugal pump is provided with an inlet and an outlet. The first outlet of the filtering mixer is connected with the inlet of the second centrifugal pump by a pipe. The outlet of the second centrifugal pump is connected with the first inlet of the second injector by a pipe. The inner surface of the reactor, the inner and outer surfaces of the internal parts of the reactor, the inner surface of the second heat exchanger, the inner and outer surfaces of the internal parts of the second heat exchanger, and inner surface of the pipes are all applied with a noble metal catalyst coating.

Further, the reactor is a second catalytic reactor. A second oxygen generator and a second ozone generator are provided within an ozone generating unit and connected by a pipe. The outlet of the second oxygen generator is connected with the first inlet of the second ozone generator by a pipe. The first outlet of the second ozone generator is connected with the second inlet of the second injector by a pipe.

The second outlet of the second heat exchanger is connected with the second inlet of the second ozone generator by a pipe. The second outlet of the second ozone generator is connected with the inlet of the cooling water tank by a pipe. The outlet of the cooling water tank is connected with the inlet of the second circulating pump by a pipe. The outlet of the second circulating pump is connected with the second inlet of the second heat exchanger by a pipe. The second ozone generator, the cooling water tank, the second circulating pump and the second heat exchanger form a cooling water circulating system. The inside of the revolving mixer is applied with a catalyst coating on the granular porous ceramic surface. The second ozone generator is provided with a cooling chamber. The second injector is a second Venturi mixer, and one or more second catalytic reactors are provided and are connected in series by a pipe.

Furthermore, the submersible pump, the second centrifugal pump, the ozone generating unit, the second injector and the second catalytic reactor are installed together in a second enclosure. One or more second enclosures are provided and connected in series by a pipe. The second inlet of the filtering mixer is provided with a filter. A gas flow meter is provided on the pipe for connecting the ozone generating unit and the second catalytic reactor. The retention time of the mixture in the second catalytic reactor is from 10 s to 500 s.

A wastewater treatment method used in a wastewater treatment system according to the present invention includes the following steps:

(1) performing pretreatment, absorption and precipitation of the wastewater;

(2) allowing the wastewater to enter the filtering mixer, which has the function of diverter, through the submersible pump;

(3) after diversion by the filtering mixer, introducing a portion of wastewater into the second centrifugal pump from the outlet of the filtering mixer, and the remaining portion of the wastewater remains in the filtering mixer;

(4) introducing the wastewater into the second injector through the second centrifugal pump at a selected speed, and the second injector produces negative pressure to take in ozone produced by the ozone generating unit, thereby forming a mixture of the ozone and the wastewater;

(5) introducing the mixture into the second catalytic reactor through pipes, allowing the mixture to fully contact the catalyst coating in the second catalytic reactor and to undergo an oxidation-reduction reaction under the catalysis of the catalyst;

(6) the second ozone generator, the cooling water tank, the second circulating pump, and the second heat exchanger form a cooling water circulating system to reduce the temperature of the second ozone generator. The wastewater exchanges heat with the cooling water that has been used to cool the second ozone generator in the heat exchanger to reduce the temperature of the cooling water. The second heat exchanger transports the wastewater to the filtering mixer, and the ozone remaining in the reaction mixes with the wastewater that does not enter the second catalytic tower;

(7) introducing wastewater that has been treated but still contains ozone into the revolving mixer from the filtering mixer. After being treated twice in a revolving mixer, the wastewater is discharged through the outlet of the revolving mixer into a body of water, in which the treated wastewater mixes with the untreated water therein to consume the remaining ozone.

The beneficial effects: a wastewater treatment system and a method thereof according to the present invention can treat more troublesome wastewater, improve the utilization rate of ozone, can be applied in a wide pH and temperature range of wastewater, take less floor area, are easy to install and operate, have low operation cost and stable treatment effects, and do not cause secondary pollution. The advanced catalytic oxidation process is adopted to generate hydroxyl free radicals, which have remarkable treatment efficacies for a majority of wastewaters. The wastewater treated by the catalytic oxidation process undergoes further reactions in the tilted-plate catalytic tower and the packed catalytic tower to significantly reduce the COD, increase the ratio of BOD/COD, and degrade toxic and hazardous substances, such that systems and methods according to the present invention have a wide application range.

(1) A bouncer for changing the incoming direction of the ozone-containing water and enlarging the area of the same is provided between the ozone generator and the first Venturi mixer. The bouncer changes the incoming direction of the ozone-containing water, increases the area of the ozone-containing water, increases the contact areas with the packings, improves the reaction efficiency, reduces the volume of the tilted-plate catalytic tower, and saves space.

(2) The wastewater inlet of the tilt-plate catalytic tower is connected with the wastewater pump, which is a submersible pump or a centrifugal pump, and a pressure controller and a flow controller are provided on the pipe to monitor and control the pressure and the flow in the pipe automatically. The wastewater pump will give an alarm or stop automatically for protection when the pressure in the pipe reaches the upper limit set. The water inlet of the tilted-plate catalytic tower is provided with a trumpet mouth facing the filter mentioned above for backwashing the filter mesh to prevent blocking.

(3) A system of the present invention can treat troublesome wastewater repeatedly until wastewater meet the discharge standards, and conduct overflow treatment or circulate a portion for small-scale experiments while processing a large-scale troublesome wastewater so as to provide effective data support for large-scale industrial applications. The system can conduct overflow treatment for a large volume of wastewater lightly polluted by organic matter or be used with other wastewater treatment means (such as biochemical processes) to conduct catalytic oxidation pretreatment for troublesome wastewater before the troublesome wastewater enters a biochemical system. The system can also re-treat wastewater that has been treated by other wastewater treatment means but is still not up to the discharge standards.

Another wastewater treatment system and the method according to the present invention, which is easy to install and use, can improve the wastewater treatment capacity and ozone utilization rate, and can effectively filter foreign matters in the surface water at the inlet to prevent pipes from blockage. This wastewater treatment system not only can disinfect surface water and rainwater, but can also treat industrial re-circulating water and the wastewater that has been treated by factories but is not up to the discharge standards. The present invention has the following advantages:

(1) The filtering mixer provided at the inlet of the equipment has the functions of filtering and self-cleaning and a filter mesh element that does not need replacement, and it can remove foreign bodies in the wastewater efficiently to prevent pipes from being blocked. The untreated wastewater at the outlet of the filtering mixer mixes with the wastewater that has been treated but still contains residual ozone to make full use of the ozone that is not completely consumed in the reaction, greatly improving the utilization rate of ozone and the wastewater treatment capability.

(2) A revolving mixer is connected at the outlet of the filtering mixer to mix the wastewater that has been treated but still contains residual ozone with the wastewater nearby by revolving so as to spread the ozone into nearby waters efficiently, improving the wastewater treatment capability and the utilization rate of ozone to a large extent, reducing energy consumption and eventually reducing operation cost.

(3) The ozone surface water treatment equipment is an automatic integrated one, easy to operate, i.e. the equipment can be placed on the bank or on a platform, which can float on the water surface freely to realize quick control of wastewater.

(4) The inside of the second catalytic reactor, the second heat exchanger and the pipes according to the present invention are all applied with noble metal catalyst coating for enhancing the capacity of the ozone to oxide wastewater, and additionally, a catalyst coating carried on the granular porous ceramic surface can be added in the revolving mixer to increase the reaction rate of ozone catalytic oxidation to a large extent.

(5) It can degrade surfactants and other polymeric organic matter in the surface water efficiently, reduce the total level of phosphorus and ammonia nitrogen in water bodies, and quickly eliminate algae and fungus to make the water bodies nontoxic and harmless, so as to solve environmental pollution problems at the root and realize zero-pollutant and environmentally-friendly discharge.

### BRIEF DESCRIPTION OF THE SEVERAL VIEWS OF THE DRAWINGS

FIG. 1 is a schematic diagram of Embodiment 1 according to the present invention;

FIG. 2 is a schematic diagram of Embodiment 2 according to the present invention;

FIG. 3 is a schematic diagram of a packed catalytic tower according to the present invention;

FIG. 4 is a schematic diagram of a tilted-plate catalytic tower according to the present invention;

FIG. 5 is a process flow diagram of a system of Embodiment 7 according to the present invention;

FIG. 6 is a schematic diagram of Embodiment 7 according to the present invention.

In the figures, 1, first centrifugal pump; 2, first Venturi mixer; 3, first oxygen generator; 4, first ozone generator; 5, first catalytic reactor; 6, first heat exchanger; 7, wastewater pump; 8, tilted-plate catalytic tower; 801, first foot; 802, end cover of first tower bottom; 803, ozone-containing water inlet; 804, bouncer; 805, solid packing for catalysts; 806, first tower top; 807, end cover of first tower top; 808, wastewater outlet; 809, wastewater inlet; 810, trumpet mouth; 811, divergence wastewater outlet; 812, filter; 813, first emptying valve; 814, first tower bottom; 815, first packing layer; 9, packed catalytic tower; 901, second foot; 902, end cover of second tower top; 903, first water inlet; 904, folded plate; 905, second tower top; 906, packing filling opening; 907, end cover of second tower bottom; 908, first water outlet; 909, second emptying valve; 910, second tower bottom; 911, second packing layer; 912, supporting layer; 10, aeration biological tower; 11, water storage tank; 12, air blower; 13, second enclosure; 14, submersible pump; 15, second centrifugal pump; 16, second Venturi mixer; 17, second catalytic reactor; 18, second heat exchanger; 19, filtering mixer; 20, revolving mixer; 21, second oxygen generator; 22, second ozone generator; 23, cooling water tank; 24, second circulating pump; 25, precision filter.

### DETAILED DESCRIPTION OF THE INVENTION

The present invention will be further described hereinafter with the drawings and the embodiments to elucidate the technical solution and the technical aim of the present invention.

### Embodiment 1

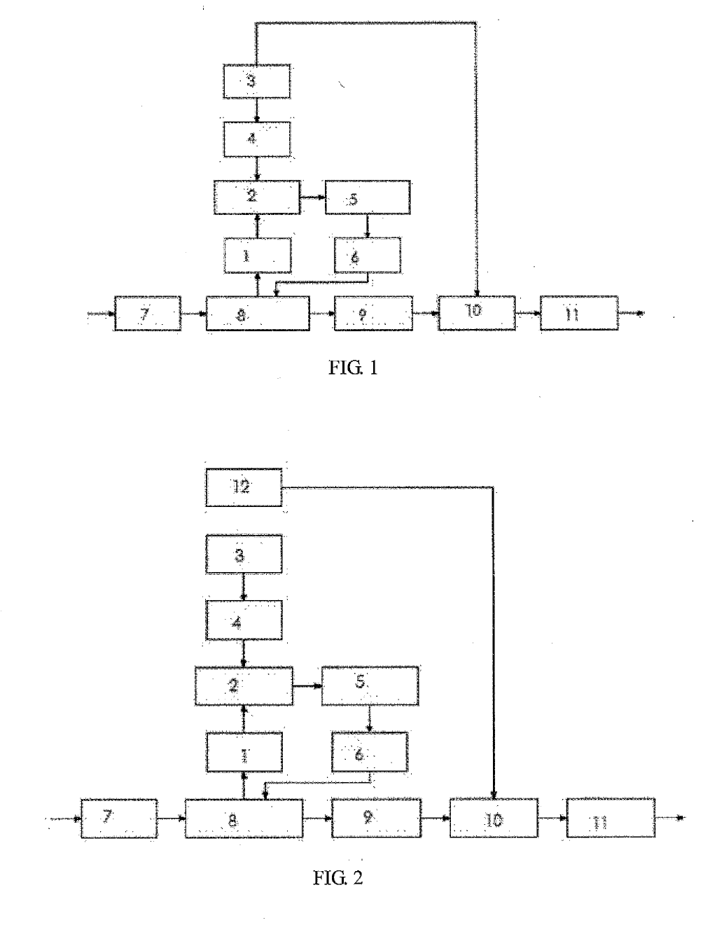

FIG. 1 illustrates a wastewater treatment system according to the present invention, comprising a first centrifugal pump 1, a first Venturi mixer 2, a 5 L/min first oxygen generator 3, a 30 g/h first ozone generator 4, a first catalytic reactor 5 with a mean outer diameter of 100 mm, a first heat exchanger 6, a wastewater pump 7 with a flow rate of 2 m³/h, a tilted-plate catalytic tower 8, a packed catalytic tower 9, an aeration biological tower 10 and a water storage tank 11;

the first oxygen generator 3, the first ozone generator 4, the Venturi injector 2, the first catalytic reactor 5, the wastewater pump 7, the first heat exchanger 6, the wastewater pump 7 and the first centrifugal pump 1 are mutually connected by pipes and installed together in a first enclosure of steel structure, the tilted-plate catalytic tower 8, the packed catalytic tower 9, the aeration biological tower 10 and a water storage tank 11 are installed together in another first enclosure, and the two first enclosures are connected by pipes and cables. The first oxygen generator 3 is tailor-made according to the oxygen demand of the first ozone generator 4.

The wastewater pump 7, the tilted-plate catalytic tower 8, the first Venturi mixer 2, the first oxygen generator 3, the first ozone generator 4, the first catalytic reactor 5, the first heat exchanger 6, the packed catalytic tower 9, the aeration biological tower 10 and the water storage tank 11 are all provided with inlets and outlets; the outlet of the wastewater pump 7 is connected with the first inlet of the tilted-plate catalytic tower 8 by a pipe;

the wastewater treatment system also comprises a cooling system which comprises a cooling water tank, a first circulating pump, a first heat exchanger 6 and a first ozone generator 4 connected in turns by pipes to form a cooling water circulating loop; the side of the first heat exchanger 6 that contacts with wastewater is applied with a catalyst coating for speeding up the catalytic oxidation of wastewater; the first heat exchanger 6 is a plate-type heat exchanger or a shell-and-tube heat exchanger;

the wastewater enters the tilted-plate catalytic tower 8 by means of the wastewater pump 7 through pipes, and the tilted-plate catalytic tower 8 has the function of divergence; some wastewater enters the first centrifugal pump 1 from the first outlet of the tilted-plate catalytic tower 8 and the rest remains in the tilted catalytic tower 8 after divergence by the tilted catalytic tower 8; the products of the oxidation-reduction reaction enter the tilted-plate catalytic tower 8 though the first heat exchanger 6, and the ozone and the oxygen remaining in the reaction mixes with the wastewater that does not enter the first catalytic reactor 5; the tilted-plate catalytic tower 8 continues to make use of remaining ozone and oxygen for catalytic reaction, increasing the reaction rate and improving the treatment effect. The pipe for connecting the wastewater pump 7 and the tilted-plate catalytic tower 8 is provided with a pressure controller and a flow controller. The wastewater inlet of the tilt-plate catalytic tower 8 is connected with the wastewater pump 7 to monitor and control the pressure and the flow in the pipe automatically. The wastewater pump 7 will give an alarm or stop automatically for protection when the pressure in the pipe reaches the upper limit set.

The first outlet of the tilted-plate catalytic tower 8 is connected with the inlet of the first centrifugal pump 1 by a pipe; the second inlet of the tilted-plate catalytic tower 8 is provided with a trumpet mouth facing the filter mesh mentioned above to backwash the filter mesh and prevent blockage.

The outlet of the first centrifugal pump 1 is connected with the first inlet of the first Venturi mixer 2 by a pipe; the wastewater is transported to the first Venturi mixer 2 through the first centrifugal pump 1 at a certain speed, and the first Venturi mixer 2 produces negative pressure to take in the ozone produced by the first ozone generator 4 and form the mixture of the ozone and the wastewater; the ozone intake of the first Venturi mixer 2 is regulated by the flow of the first centrifugal pump 1 and the valve on the pipe.

The first oxygen generator 3 is provided with an air compressor, the second inlet of the aeration biological tower 10 is connected with the second outlet of the first oxygen generator 3 by pipes, the first outlet of the first oxygen generator 3 is connected with the inlet of the first ozone generator 4 by a pipe; air is generated by making full use of the first oxygen generator 3, saving energy effectively.

The oxygen made by the first oxygen generator 3 is introduced into the first ozone generator 4, and the outlet of the first ozone generator 4 is connected with the second inlet of the first Venturi mixer 2 by a pipe;

The outlet of the first Venturi mixer 2 is connected with the inlet of the first catalytic reactor 5 by a pipe; the wastewater fully contacts the catalyst coating in the first catalytic reactor 5 and undergoes oxidation-reduction reaction under the action of the catalyst.

The outlet of the first catalytic reactor 5 is connected with the inlet of the first heat exchanger 6 by means of pipe; the outlet of the first heat exchanger 6 is connected with the second inlet of the tilted-plate catalytic tower 8 by a pipe.

The tilted-plate catalytic tower 8 is provided with solid packings for inert noble metal catalysts which are in the form of folded plates and tilted plates and arranged according the direction of water flow. The packing, arranged in N layers, fill the tower up, effectively increasing the contact area for the catalytic reaction and decreasing the volume of the catalytic tower and the floor area of the apparatus.

The second outlet of the tilted-plate catalytic tower 8 is connected with the inlet of the packed catalytic tower 9 by a pipe, and the tilted-plate catalytic tower 8 continues to make use of remaining ozone and oxygen for catalytic reaction, increasing the reaction rate and improving the treatment effect.

The space above the folded plates in the packed catalytic tower 9 is not packed, and the particle packings fed are not only applied with inert noble metal powder catalysts on their surfaces, but also porous, providing a larger contact area with the wastewater so as to make better use of oxygen and ozone for reaction.

The packed catalytic tower 9 continues to make use of the remaining oxygen and ozone for catalytic-oxidation so as to further improve the effect of wastewater treatment; after gas-liquid separation in the top corner of the folded plates in the packed catalytic tower 9, ozone and oxygen are blocked within the space, and the gases will enter the wastewater again due to the limitation of space, prolonging the contact and reaction time of the gases and the wastewater, improving the utilization rate of ozone and realizing a high reaction efficiency.

The outlet of the packed catalytic power 9 is connected with the first inlet of the aeration biological tower 10 by a pipe;

multiple layers of tilted folded-plates are provided in the packed catalytic tower 9, particle catalytic packings applied with inertia noble metal powders are fed from the packing feeding opening at the tower top to fill the space among the folded plates, but a triangle top corner of the folded plates is not filled so that after remaining ozone and oxygen enter the packed catalytic tower 9 and are separated from the liquid, the ozone and oxygen are blocked within the space, and the gases will enter the wastewater again due to the limitation of space as they accumulate to a certain amount, prolonging the contact and reaction time of the gases and the wastewater, improving the utilization rate of ozone and realizing a high reaction efficiency.

Porous packings suitable for the attached growth of microorganisms are provided in the aeration biological tower 10, multiple layers of tilted folded-plates are provided in the aeration biological tower 10 and the packed catalytic tower 9, the projections of the folded plates overlap, and the included angle between each layer of the folded plates and the central axis of the tower body is 30-89°. The projection length of the folded plates exceeds the length of the central axis of the tower body by 5-500 mm;

The top corner of the folded plates in the aeration biological tower 10 is used to prevent the air from escaping, prolonging the contact and reaction time of the air and wastewater, improving the utilization rate of the air and ensuring the concentration of the dissolved oxygen in the tower. The aeration biological tower 10 is filled with porous packings to which microorganisms can attach, so the packings have a larger specific surface area, which helps the attached growth and reproduction of microorganisms.

The outlet of the packed catalytic power 10 is connected with the first inlet of the water storage tank 11 by a pipe. The packed catalytic tower 9 is filled with particle packings of inertia noble metal powders, and the particle packings have a specific surface area of 0.1-100 m²/g.

The outlet of the aeration biological tower 10 is connected with the inlet of the water storage tank 11, and the outlet of the water storage tank 11 is provided with a sampling opening. The wastewater that is up to standard upon sampling and analysis can be discharged. The air for aeration in the aeration biological tower 10 comes from the divergence pipe of the air compressor of the first air generator 3 so as to make better use of the air generated by the air compressor and reduce wasted energy. The second inlet of the aeration biological tower 10 is provided with an aeration network and an aeration tray in such a way that the air is defused in very small bubbles into the wastewater to increase the contact area between the air and wastewater and the utilization rate of air, thereby ensuring that organisms grow and reproduce in aerobic conditions and degrade organic matter in the wastewater.

The wastewater treatment system also comprises a bouncer for changing the incoming direction of the ozone-containing water and enlarging the area of the same and a filter; the bouncer is arranged between the ozone generator and the first Venturi mixer 2; the bouncer changes the incoming direction of the ozone-containing water, enlarges the area of the same, increases the contacts area with the packings, improves the reaction efficiency, reduces the volume of the tilted-plate catalytic tower 8 and saves more space.

The first outlet of the tilted-plate catalytic tower 8 is provided with a filter mesh to remove foreign bodies in the wastewater as so to prevent foreign bodies from entering the tilted-plate catalytic tower 8 and the pipes of the equipment. The wastewater can wash away the foreign bodies on the surface of the filter, achieving the effecting of cleaning the filter.

The outlet of the wastewater pump 7, the tilted-plate catalytic tower 8, the first centrifugal pump 1, the first Venturi mixer 2, the first oxygen generator 3, the first ozone generator 4, the first catalytic reactor 5, the first heat exchanger 6, the packed catalytic tower 9, the aeration biological tower 10 and the water storage tank 11 are all connected with a T-adaptor, and provided with a sampling opening valve for sampling and analysis.

The wastewater pump 7 is a submersible pump; the mixture retains over 10 s in the wastewater treatment system. The reaction time is determined by the flow of the wastewater pump 7 as well as the number and the specifications of the series or parallel reactor, and the effect of wastewater treatment is controlled through the ozone intake as well as the number and the operation time of the units of a piece of integrated wastewater treatment equipment.

The present invention can be changed in terms of the internal fittings of the equipment, the parameters of the tilted-plate catalytic tower 8, the packed catalytic tower 9 and the aeration biological tower 10, the retention time for reaction, the catalyst feeding amount and the dimensions to form a process system apparatus which have different treatment capacities, catalyst feeding amounts, ozone feeding amounts and reaction time based on the water yield and water quality of troublesome wastewater; besides, the process system can be made into one or more pieces of modular equipment depending on wastewater yield and wastewater quality, and these pieces of modular equipment are connected through pipes or cables, easy to disassemble and install.

A wastewater treatment method according to the present invention, including the following steps:

(1) conduct pretreatment, absorption and precipitation for the wastewater; the wastewater enters the tilted-plate catalytic tower 8 by means of the wastewater pump 7 through pipes, and the tilted-plate catalytic tower 8 has the function of divergence; some wastewater enters the first centrifugal pump 1 from the first outlet of the tilted-plate catalytic tower 8 and the rest remains in the tilted catalytic tower 8 after divergence by the tilted catalytic tower 8; the tilted-plate catalytic tower 8 has a large volume so that only a part of the water is pumped into the first catalytic reactor 5 by the first centrifugal pump 1 and then flows back to the tilted-plate catalytic tower 8 where it mixes with the water that remains in the tilted-plate catalytic tower 8 and the mixture flows together into the packed catalytic tower 9; the pipe for connecting the wastewater pump 7 and the tilted-plate catalytic tower 8 is provided with a pressure controller and a flow controller. The wastewater pump 7, the tilted-plate catalytic tower 8, the first Venturi mixer 2, the first oxygen generator 3, the first ozone generator 4, the first catalytic reactor 5, the first heat exchanger 6, the packed catalytic tower 9, the aeration biological tower 10 and the water storage tank 11 are all provided with inlets and outlets.

(2) the wastewater is transported to the first Venturi mixer 2 through the first centrifugal pump 1 at a certain speed, and the first Venturi mixer 2 produces negative pressure to take in the ozone produced by the first ozone generator 4 and form the mixture of the ozone and the wastewater; the ozone intake of the first Venturi mixer 2 is regulated by the flow of the first centrifugal pump 1 and the valve on the pipe;

the first oxygen generator 3 is provided with an air compressor, the second inlet of the aeration biological tower 10 is connected with the second outlet of the first oxygen generator 3 by pipes; the inlet of the first ozone generator 4 is connected with the first outlet of the first oxygen generator 3 by a pipe; the oxygen made by the first oxygen generator 3 is introduced into the first ozone generator 4; the first oxygen generator 3 is provided according to the oxygen demand of the first ozone generator 4.

A bouncer for changing the incoming direction of the ozone-containing water and enlarging the area of the same is provided between the first ozone generator 4 and the first Venturi mixer 2; the bouncer changes the incoming direction of the ozone-containing water, enlarges the area of the same, increases the contacts area with the packings, improves the reaction efficiency, reduces the volume of the tilted-plate catalytic tower 8 and saves more space.

(3) After mixing in the first Venturi mixer 2, the mixture enters the first catalytic reactor 5 through pipes, fully contacts the catalyst coating in the first catalytic reactor 5 and undergoes an oxidation-reduction reaction under the catalysis of the catalyst;

(4) the products of the oxidation-reduction reaction enter the tilted-plate catalytic tower 8 though the heat exchanger, and the ozone and the oxygen remaining in the reaction mixes with the wastewater that does not enter the first catalytic reactor 5; the tilted-plate catalytic tower 8 continues to make use of remaining ozone and oxygen for catalytic reaction, increasing the reaction rate and improving the treatment effect. The tilted-plate catalytic tower 8 is provided with solid packings for inert noble metal catalysts and multiple layers of tilted folded-plates. The internal packings of the tilted-plate catalytic tower 8 are arranged in N layers according the direction of water flow, and fill up the inner space of the tilted-plate catalytic tower 8, effectively increasing the contact area for the catalytic reaction and decreasing the volume of the catalytic tower and the floor area of the apparatus. The first outlet of the tilted-plate catalytic tower 8 is provided with a filter mesh of stainless steel to remove foreign bodies in the wastewater. The filter mesh removes the foreign bodies in the wastewater and prevents them from entering the tilted-plate catalytic tower 8 and the pipes of the equipment. The wastewater can wash away the foreign bodies on the surface of the filter, achieving the effecting of cleaning the filter.

(5) the reaction products enter the packed catalytic tower through the second outlet of the tilted-plate catalytic power 8, and the remaining ozone and oxygen undergo a full oxidation-reduction reaction with the wastewater, improving the effect of wastewater treatment; particle catalytic packings applied with inertia noble metal powders and with a specific surface area of 0.1-100 m²/g and tilted folded-plates are provided in the packed catalytic tower 9, and the space between the folded plates and the inner wall of the packed catalytic tower 9 is filled with the packings. After gas-liquid separation in the top corner of the folded plates in the packed catalytic tower 9, ozone and oxygen are blocked within the space, and the gases will enter the wastewater again due to the limitation of space, prolonging the contact and reaction time of the gases and the wastewater, improving the utilization rate of ozone and realizing a high reaction efficiency.

(6) the outlet of the packed catalytic tower 9 is connected with the first inlet of the aeration biological tower 10 by a pipe, and the reaction products enter the aeration biological tower 10 through the outlet of the packed catalytic tower 9; the outlet of the aeration biological tower 10 is connected with the inlet of the water storage tank 11 by a pipe for water to flow from the aeration biological tower 10 into the water storage tank 11, and the outlet of the water storage tank 11 is provided with a sampling opening for sampling and analysis.

Porous packings suitable for the attached growth of microorganisms are provided in the aeration biological tower 10, multiple layers of folded plates are provided in the aeration biological tower 10 and the packed catalytic tower 9, the projections of the folded plates overlap, and the included angle between each layer of the folded plates and the central axis of the tower body is 30-89°.

The projection length of the folded plates exceeds the length of the central axis of the tower body by 5-500 mm;

The top corner of the folded plates is used to prevent the air from escaping, prolonging the contact and reaction time of the air and wastewater, improving the utilization rate of the air and ensuring the concentration of the dissolved oxygen in the tower.

The second inlet of the aeration biological tower 10 is provided with an aeration network and an aeration tray to increase the utilization rate of air, thereby ensuring that organisms grow and reproduce in aerobic conditions and degrade organic matter in the wastewater. The air for aeration in the aeration biological tower 10 comes from the divergence pipe of the air compressor of the first air generator 3 so as to make better use of the air generated by the air compressor and reduce wasted energy.

The apparatus in the wastewater treatment method comprises a first centrifugal pump 1, a first Venturi mixer 2, a 5 L/min first oxygen generator 3, a 30 g/h first ozone generator 4, a first catalytic reactor 5 with a mean outer diameter of 100 mm, a first heat exchanger 6, a wastewater pump 7 with a flow rate of 2 m³/h, a tilted-plate catalytic tower 8, a packed catalytic tower 9, an aeration biological tower 10 and a water storage tank 11;

the wastewater pump 7 is a submersible pump; the mixture retains over 10 s, even over 100 h, in the wastewater treatment system. The reaction time is determined by the flow of the wastewater pump 7 as well as the number and the specifications of the series or parallel reactor, and the effect of wastewater treatment is controlled through the ozone intake as well as the number and the operation time of the units of an integrated wastewater treatment equipment.

The outlet of the wastewater pump 7 is connected with the first inlet of the tilted-plate catalytic tower 8 by a pipe; the first outlet of the tilted-plate catalytic tower 8 is connected with the inlet of the centrifugal pump 7 by a pipe.

The present invention, easy to install and operate, can improve the wastewater treatment capacity and the utilization rate of ozone, apply to a wide pH and temperature range of wastewater, and filter mesh foreign bodies in the wastewater effectively to prevent pipes from being blocked, takes less floor area, has low operation cost and stable treatment effects and does not cause secondary pollution. The equipment not only can treat various troublesome industrial wastewater and the wastewater that has been treated by factories but is not up to standard, but also can treat industrial re-circulating water, especially highly troublesome wastewater.

(1) A bouncer for changing the incoming direction of the ozone-containing water and enlarging the area of the same is provided between the first ozone generator 4 and the first Venturi mixer 2; the bouncer changes the incoming direction of the ozone-containing water, enlarges the area of the same, increases the contacts area with the packings, improves the reaction efficiency, reduces the volume of the tilted-plate catalytic tower 8 and saves more space.

(3) Multiple layers of tilted folded-plates are provided and arranged at an angle of 30-89° in the packed catalytic tower 9, particle catalytic packings applied with inertia noble metal powders are fed from the packing feeding opening at the tower top to fill the space among the folded plates, but a triangle top corner of the folded plates is not filled so that after remaining ozone and oxygen enter the tower and are separated from the liquid, the ozone and oxygen are blocked within the space, and the gases will enter the wastewater again due to the limitation of space as they accumulate to a certain amount, prolonging the contact and reaction time of the gases and the wastewater, improving the utilization rate of ozone and realizing a high reaction efficiency. The particle packings fed are not only applied with inert noble metal powder catalysts on their surfaces, but also porous, providing a larger contact area with the wastewater so as to make better use of oxygen and ozone for rapid and high-efficiency catalytic reaction.

(4) The second inlet of the aeration biological tower 10 is connected with the air compressor of the first air generator 3 to make full use of the air generated by the air compressor of the first air generator 3 and save energy effectively. The second inlet of the aeration biological tower 10 is provided with an aeration network and an aeration tray in such a way that the air is defused in very small bubbles into the wastewater to effectively increase the contact area between the air and wastewater and the utilization rate of air, thereby ensuring that organisms grow and reproduce in aerobic conditions and degrade organic matter in the wastewater. Multiple layers of tilted folded-plates are provided and arranged at an angle of 50-60° in the aeration biological tower 10, and the top corner of the folded plates is used to prevent the air from escaping, prolonging the contact and reaction time of the air and wastewater, improving the utilization rate of the air and ensuring the concentration of the dissolved oxygen in the tower. The tower is filled with porous packings to which microorganisms can attach, so the packings have a larger specific surface area, which helps the attached growth and reproduction of microorganisms.

(5) The advanced catalytic oxidation process is adopted in the present invention to generate hydroxyl free radicals, which has apparent effects for a majority of wastewater, and the wastewater treated by the catalytic oxidation undergoes further reactions in the tilted-plate catalytic tower and the packed catalytic tower to significantly reduce the COD, raise the ratio of B/C and degrade toxic and hazardous substances, so the present invention has a wide application range. The present invention can treat troublesome wastewater cyclically until the wastewater is up to standard, and conduct overflow treatment or bench-scale experiments for big-yield troublesome wastewater so as to provide effective data support for big-yield industrialization; conduct overflow treatment for big-yield water bodies lightly polluted by organic matter or be used with other wastewater treatment means (such as biochemical processes) to conduct catalytic oxidation pretreatment for troublesome wastewater before the troublesome wastewater enters a biochemical system; and re-treat the wastewater that has been treated by other wastewater treatment means but is still not up to standard.

(6) The equipment in the present invention, all made of stainless steel, is weak acid resistant and alkaline resistant, and the catalytic oxidation adopted, applying to a wide pH and temperature range of the wastewater, can ensure that the system has its effect of wastewater treatment from pH >6.5 and a water temperature of 0-50° C. The present invention can be changed in terms of the internal fittings of the equipment, the parameters of the tilted-plate catalytic tower 8, the packed catalytic tower 9 and the aeration biological tower 10, the retention time for reaction, the catalyst feeding amount and the dimensions to form a process system apparatus which have different treatment capacities, catalyst feeding amounts, ozone feeding amounts and reaction time based on the water yield and water quality of troublesome wastewater; besides, the process system can be made into one or more pieces of modular equipment depending on wastewater yield and wastewater quality, and these pieces of modular equipment are connected through pipes or cables, easy to disassemble and install.

A cyclic treatment experiment is made to the wastewater containing a high concentration of phenol from a petrochemical plant. The COD of the water is reduced from 1840 mg/L to 714 mg/L and the degradation rate of COD is 61.2% after treatment for 3 hours, and the specific data are shown in Table 1 below.

TABLE 1

| | | | Degradation |
|---|---|---|---|
| Water Quality | | After | Rate of COD |
| Parameter | Original Sample | Treatment for 3 h | (%) |
| COD (mg/L) | 1840 | 714 | 61.2 |
| Chromaticity | Yellow | Colorless | — |

Table 1 shows that the wastewater becomes colorless at the outlet from the original yellow, indicating that the embodiment has good degradation effect for the phenol-containing wastewater and obvious de-coloration effect.

### Embodiment 2

As shown in FIG. 2, the difference between Embodiment 2 and Embodiment 1 lies in that: The wastewater treatment system also comprises an air blower 12, and the second inlet of the aeration biological tower 10 is connected with the second outlet of the air blower 12; the outlet of the air blower 12 is connected with the inlet of the first oxygen generator 3 by a pipe. The wastewater pump 7 is a centrifugal wastewater pump; the first oxygen generator 3 is a molecular-sieve oxygen generator;

in Step (2), the second inlet of the aeration biological tower 10 is connected with the air blower 12 by a pipe.

Cyclic treatment is made to refuse leachate, and the data before and after treatment are shown in Table 2.

TABLE 2

| | | After | | |
|---|---|---|---|---|
| Water Quality | Original | Treatment | After Treatment | Degradation |
| Parameter | Sample | for 30 min | for 2 h | Rate |
| pH | 7.82 | 7.72 | 7.50 | — |
| COD (mg/L) | 7525 | 1956 | 752.5 | 90% |
| Ammonia | 490.2 | 323.2 | 306.1 | 37.6% |
| nitrogen (mg/L) | | | | |
| Total | 1.70 | 1.57 | 0.75 | 55.9% |
| phosphorus | | | | |
| (mg/L) | | | | |
| Chromaticity | 350 | 100 | 30 | 91.4% |

As we can see from Table 2, after refuse leachate wastewater is treated for 30 min, the COD is reduced from 7525 mg/L to 1956 mg/L, and the COD is reduced to 752.5 mg/L and the degradation rate of COD is reduced to 90% after treatment for 2 h; the degradation rate of ammonia nitrogen, total phosphorus and chromaticity are 37.6%, 55.9% and 91.4% respectively after treatment for 2 h.

### Embodiment 3

The difference between Embodiment 3 and Embodiment 1 lies in that: An overflow treatment experiment is made to the wastewater that has been treated by the wastewater treatment station of an alcohol plant but is not up to standard, and the data before and after the treatment are shown in Table 3.

TABLE 3

| | Parameter | | |
|---|---|---|---|
| Overflow | | COD After | |
| Water Yield | | Overflow Treatment | Degradation Rate of |
| (L) | COD (mg/L) | (mg/L) | COD (%) |
| 100 | 451 | 382.2 | 15.3 |
| 200 | 452.6 | 393.6 | 13.0 |
| 300 | 468.5 | 409.9 | 12.5 |
| 400 | 480.2 | 460.2 | 4.16 |
| 500 | 480.2 | 460.2 | 4.16 |
| 600 | 468.5 | 429.4 | 8.35 |
| 700 | 468.5 | 429.4 | 8.35 |
| 800 | 452.6 | 423.1 | 6.52 |
| 900 | 468.5 | 439.2 | 6.25 |
| 1000 | 450.8 | 411.6 | 8.70 |

As we can see from Table 3, an overflow treatment is made to the wastewater that has been treated by the wastewater treatment station of an alcohol plant but is not up to standard, where the wastewater is introduced in different flows and the CODs of the wastewater are all reduced to some extent, and the lower the flow of the wastewater is, the longer the reaction time is, the higher the treatment efficiency is, and the higher the degradation rate of COD is.

### Embodiment 4

The difference between Embodiment 4 and Embodiment 1 lies in that: An overflow treatment experiment is made to printing and dyeing wastewater, where treatment of the wastewater for one time with the system adopting the treatment method is regarded as one treatment cycle; when the inflow of the wastewater is 100 L/H, two treatment cycles are made to the wastewater by adopting the wastewater treatment method, the data of one treatment cycle and two treatment cycles are given in Table 4.

TABLE 4

| | | Degradation Rate of | Chromaticity |
|---|---|---|---|
| Name | COD (mg/L) | COD (%) | (degree) |
| Original water | 1390 | — | 800 |
| One treatment cycle | 1000 | 28.1 | 600 |
| Two treatment | 858 | 38.3 | 50 |
| cycles | | | |

As we can see from Table 4, two treatment cycles are made to printing and dyeing wastewater by adopting the wastewater treatment method, where the wastewater is introduced in the same flow equal to 100 L/H and the CODs of the wastewater are all reduced to some extent; in the second treatment cycle of the wastewater using the method, the reaction time is long, so it has higher the treatment efficiency, higher degradation rate of COD and more obvious degradation of chromaticity.

### Embodiment 5

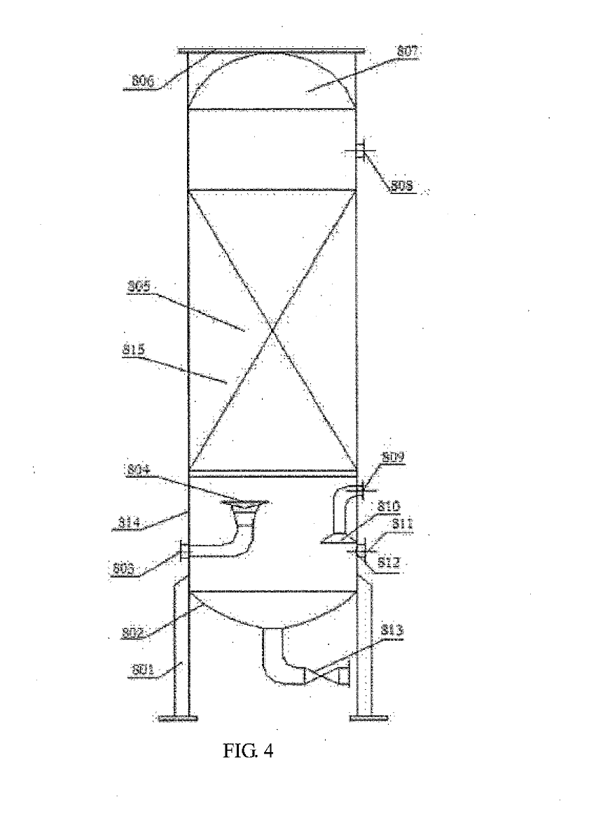

As shown in FIG. 4, the tilted-plate catalytic tower 8 according to the present invention comprises first feet 801, the body of a reaction tower is provided on the first feet 801, and the body of the reaction tower comprises a first tower bottom 814, a first packing layer 815 and a first tower top 806 from bottom to top; the first tower bottom 814 has an end cover 802 of the first tower bottom at the bottom and has an ozone-containing water inlet 803 and a wastewater inlet 809 on the side walls, and the end cover 802 of the tower bottom is attached with a first emptying valve 813; the first packing layer 815 is filled with solid packings for catalysts 805; the first tower top 806 is provided with an end cover 7 of the first tower top, and provided with a wastewater outlet 808 at its one side wall; a divergence wastewater outlet 808 is provided below the wastewater inlet 809 on the side wall of the first tower bottom 814.

The divergence wastewater outlet 811 is provided with a filter mesh 812.

The end of the L-shaped wastewater inlet 809 is connected with a trumpet mouth 810 facing downward and just opposite to the filter mesh 812. The wastewater inlet is used to wash away particle foreign bodies on the filter mesh and prevent the filter mesh from being blocked. The bore of the trumpet can be changed to increase the outgoing area of the water and the backwash area of the filter, thereby improving the mixing efficiency.

The end cover 802 of the first tower bottom is arc-shaped to increase the volume for storing precipitates and facilitate the sedimentation of precipitates under the gravity, and the emptying valve 813 at the bottom facilitates timely discharge of the precipitates in the wastewater and prevents the filter mesh and the packings from being blocked; the end cover of the tower top is arc-shaped to improve the pressure bearing capacity for the gases in the tower, and the divergence wastewater outlet 811 is connected with a filter mesh to filter mesh suspended particles and large fibrous foreign bodies to ensure the normal operation of the pump and the subsequent systems and prevent large particle matter from blocking the pipes and winding the impellers of the pump so as to provide a higher-efficiency catalytic reaction in the wastewater treatment.

The whole body of the tilted-plate catalytic tower 8 is made of stainless steel to provide effective protection against wastewater and ozone.

The L-shaped ozone-containing inlet 803 is provided with a bouncer 804. The flow direction is changed and the flow rate is decreased after the incoming ozone-containing water is bounced by the bouncer so that the ozone-containing water mixes more uniformly with the wastewater in the tower, increasing the contact area with the catalysts in the tower, prolonging reaction time and improving the reaction efficiency.

Packing support plates are provided in the first packing layer 815, solid packings which are folded plates or tilted plates with rough surfaces are loaded on the support plates, the surfaces are applied with an inert noble metal catalyst, and the included angle of 80-90° between the folded plates or tilted-plates can facilitate the flowing of the water and reduce resistance. The inert noble metal catalyst is implemented with one of existing inert noble metal catalysts, such as the inert noble metal catalyst of gold (Au), silver (Ag), platinum (Pt), palladium (Pd), rhodium (Rh), iridium (Ir), osmium (Os) and ruthenium (Ru) disclosed in the prior art.

The solid packings, arranged in N layers, fill up the inner space of the first packing layer 815, effectively increasing the contact area for the catalytic reaction and decreasing the volume of the catalytic tower and the floor area of the apparatus.

The wastewater outlet 808 is connected with a T-adaptor, and provided with a sampling opening for sampling and analysis of the treated wastewater.

The wastewater enters the tower through the wastewater inlet 809, the flow of the wastewater is regulated by the valve provided at the wastewater inlet 809, the flow direction is changed through the elbow of the wastewater inlet 809, the wastewater inlet 809 is provided with a trumpet mouth 810 to increase the flow area, effectively flush the filter mesh at the divergence wastewater outlet 811, prevent the filter mesh from being blocked and save energy. A part of the wastewater in the tower enters a piece of Virtue & Clean equipment for mixing and reaction with the ozone through the divergence wastewater outlet 811 after some foreign bodies are removed by the filter mesh 812, the other part flows upward in the tower. The mixture of the wastewater and the ozone enters the tower through the ozone-containing water inlet 803 on the tilted-plate catalytic power 8. As the water current is blocked and bounced by the bouncer 804, the flow direction is changed so that the water current is spread around to improving the efficiency of mixing with the original wastewater, increase the contact area with the catalysts in the tower, and slow down the flow rate of the water, reducing the scouring and abrasion to the internal structure of the tower. The wastewater flows past multiple layers of solid packings for catalysts on the tilted plates arranged in the same direction with the water current, and under the action of the catalysts, the ozone and the wastewater react and produce oxidizing radical groups which rapidly oxidize and degrade hazardous matter and polymeric organic matter in the wastewater, thereby achieving the aim of treating the wastewater. The treated wastewater is vented through the wastewater outlet 808 at the upper part of the tower, and the pipe of the wastewater outlet 808 is provided with a Tee and a sampling valve for sampling. The end cover of the tower bottom of the tilted-plate catalytic tower 8 is arc-shaped to increase the volume for storing precipitates and facilitate the sedimentation of precipitates under the gravity, the bottom is provided with a drainage valve 813 to facilitate timely discharge of the precipitates in the wastewater and drainage of the wastewater in the tower to prevent too many precipitates from blocking the filter mesh and the packings.

The tilted-plate catalytic tower 8 according to the present invention can be changed in terms of the dimensions design of the tower body based on the water yield and the water quality of the wastewater (the diameter and the height of the tower body are changed to change the volume in the tower), or the incoming flow can be regulated through the regulating valve at the inlet to ensure that the wastewater stays in the tower for a sufficiently long time to be suitable for treating the wastewater of various water yields and water quality, so the present invention have a wide application range.

The tilted-plate catalytic tower 8 designed and made in accordance with the technical solution of the present invention is connected with a Virtue & Clean integrated clean-waste water machine (it provides ozone and the ozone mixes with the wastewater) by a pipe for wastewater treatment. The method has a better wastewater treatment effect, shorter reaction time, higher reaction efficiency, greater degradation rate of COD and better effects for chromaticity and odor than the treatment method with ozone alone does.

For example, the tilted-plate catalytic tower 8 is connected with a Virtue & Clean integrated waste-clean water machine for treating printing and dyeing wastewater. After treatment, the decoloration effect is obvious and the COD is reduced from 1660 mg/L from 907 mg/L and the degradation rate reaches 45.4%. See Table 5 for details:

TABLE 5

| Water Quality | | After | Degradation |
|---|---|---|---|
| Parameter | Original Sample | Treatment for 3 h | Rate |
| COD (mg/L) | 1660 | 907 | 45.4% |
| Chromaticity | Dark brown | Light yellow | — |

### Embodiment 6

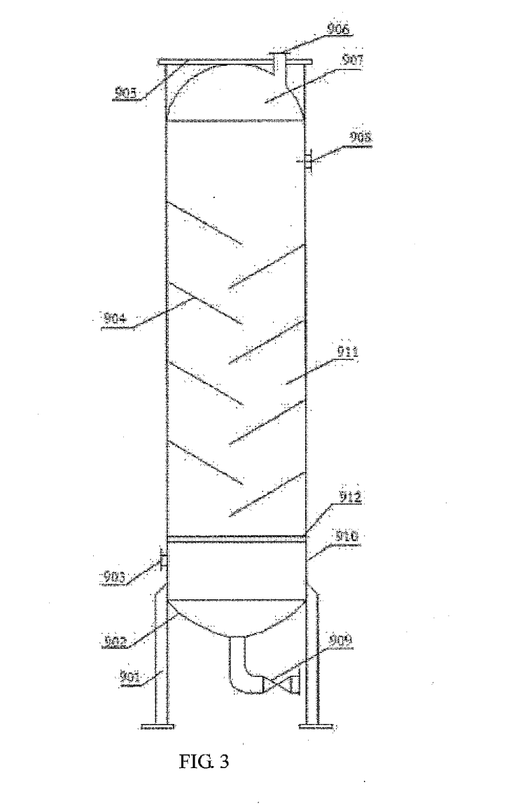

As shown in FIG. 3, the packed catalytic tower 9 according to the present invention comprises second feet 901, the body of a reaction tower is provided on the second feet, and the body of the reaction tower comprises a water incoming segment, a supporting layer 912, a second packing layer 911 and a clean-water outgoing segment from bottom to top; the water incoming segment comprises a second tower bottom 910, the second tower bottom 910 has an end cover 902 of the second tower bottom at the bottom, and the end cover 902 of the tower bottom is attached with a second emptying valve 909; the second packing layer 911 is filled with packings and has a first water outlet 908 on the upper end of its one side wall, folded plates 904 are provided in the second packing layer 911, and one end of the folded plates 904 are attached to the inner wall of the second packing layer 911 while the other end tilts downward; the clean-water outgoing segment comprises a tower top 5 which has an end cover 902 of the second tower top, and the end cover 902 of the second tower top is provided with a packing filling opening 906.

The body of the packed catalytic tower 9 made of stainless steel can provide effective protection against wastewater, acid and alkaline, and prolong the service life. The catalytic oxidation adopted in the tower, applying to a wide range of pH, temperature and organic matter content of the wastewater, can ensure that the system has its effect of wastewater treatment from pH >6.5, a water temperature of 0-50° C. and a concentration of COD>50 mg/L.

The end cover 907 of the second tower bottom is arc-shaped to increase the volume for storing precipitates and facilitate the sedimentation of precipitates under the gravity, and the bottom is provided with a drainage valve to facilitate timely discharge of the precipitates in the wastewater and prevent the packings from being blocked;

The end cover 902 of the second tower top is arc-shaped to increase the effective volume and the pressure bearing capacity of the tower so as to prevent the tower top from deforming or cracking due to too great pressure in the tower.

The stainless steel supporting layer 912 is a round plate, which is evenly arranged with round holes or square holes with a diameter or side length of 4-10 mm, and made of stainless steel.

The packings in the second packing layer 911 are porous particle packings whose surfaces are applied with an inert noble metal catalyst; the inert noble metal catalyst is implemented with one of existing inert noble metal catalysts, such as the inert noble metal catalyst of gold (Au), silver (Ag), platinum (Pt), palladium (Pd), rhodium (Rh), iridium (Ir), osmium (Os) and ruthenium (Ru) disclosed in the prior art; the packings with a large contact area of 0.1-100 m²/g has a large contact area with the wastewater so as to make better use of oxygen and ozone for rapid and high-efficiency catalytic reaction. The packings can also filter, absorb and remove some suspended particles in the wastewater to provide clean outgoing water.

Multiple layers of folded plates are alternately arranged in the second packing layer 911, the projection length of each layer of the folded plates in the horizontal plane exceeds the length of the central axis of the tower body by 5-500 mm, i.e. the projections of the folded plates in the horizontal plane overlap, and the included angle between each layer of the folded plates and the central axis of the tower body is 30-89°; a particle catalytic packing applied with inertia noble metal powders are fed from the packing feeding opening 906 at the second tower top 905 to fill the space among the folded plates, but a triangle top corner of the folded plates is not filled so that after remaining ozone and oxygen enter the tower and are separated from the liquid, the ozone and oxygen are blocked within the space, and the gases will enter the wastewater again due to the limitation of space as they accumulate to a certain amount, prolonging the contact and reaction time of the gases and the wastewater, improving the utilization rate of ozone, realizing a high reaction efficiency, effectively shortening the reaction time of the wastewater, reducing the volume of the packed catalytic tower and saving more space.

The first water outlet 908 is connected with a T-adaptor, and provided with a sampling opening for sampling and analysis of the treated wastewater.

The first water outlet 908 is connected with a backwash pump which is used to backwash the packed catalytic tower 9 periodically, the backwash water is discharged through the T-adaptor valve of the first water inlet 903, the downward orientation of the tilted-plates in the tower reduces backwash resistance, speeds up backwash and provides a good backwash effect. The packings are not easily blocked and hardened thanks to backwashing, prolonging the service life.

The first water outlet 908 of the packed catalytic tower 9 is connected with a T-adaptor valve for connecting with a backwash pump which is used to backwash the packed catalytic tower periodically, the backwash water is discharged through the T-adaptor valve of the first water inlet 903, the downward orientation of the tilted-plates in the tower reduces backwash resistance, speeds up backwash and provides a good backwash effect. The packings are not easily blocked and hardened thanks to backwashing, prolonging the service life.

The wastewater containing ozone, oxygen or air enters the tower through the first water inlet 903 and flows upward, particle catalytic packings applied with inertia noble metal powders are fed from the packing feeding opening 906 at the second tower top 905, and the packing feeding opening 906 must be closed after the packings are fed to prevent gases from escaping. The packings fill the space among the folded plates, but a top corner of the folded plates is not filled, providing a larger contact area between the packings and the wastewater so as to make better use of oxygen and ozone for reaction. After gas-liquid separation in the top corner of the folded plates in the packed catalytic tower 9, ozone and oxygen are blocked within the space, and the gases will enter the wastewater again due to the limitation of space, prolonging the contact and reaction time of the gases and the wastewater, improving the utilization rate of ozone and realizing a high reaction efficiency. The wastewater flows past the packings, and under the action of the catalysts on the packings, the ozone, the oxygen or the air and wastewater react and produce oxidizing radical groups which rapidly oxidize and degrade hazardous matter and polymeric organic matter in the wastewater, thereby achieving the aim of treating the wastewater. The packings can also filter, absorb and remove some suspended particles to provide clean outgoing water. The treated wastewater is vented through the first wastewater outlet 908 at the upper part of the tower, and the pipe of the first wastewater outlet 908 is provided with a T-adaptor and a sampling valve for sampling. The end cover 907 of the second tower bottom of the packed catalytic tower 9 is arc-shaped to increase the volume for storing precipitates and facilitate the sedimentation of big and heavy precipitates under the gravity, the bottom is provided with a second drainage valve 909 to facilitate timely discharge of the precipitates in the wastewater and drainage of the wastewater in the tower to prevent too many precipitates from blocking the packings;

The tilted-plate catalytic tower 9 according to the present invention can be changed in terms of the dimensions design of the tower body based on the water yield and the water quality of the wastewater, or the incoming flow can be regulated through the regulating valve at the inlet to ensure that the wastewater stays in the tower for a sufficiently long time to be suitable for treating the wastewater of various water yields and water quality, so the present invention have a wide application range.

The tilted-plate catalytic tower 9 designed and made in accordance with the technical solution of the present invention is connected with the first catalytic reactor 5 and a Virtue & Clean integrated clean-waste water machine (it provides ozone and the ozone mixes with the wastewater) by a pipe for wastewater treatment. The method has a better wastewater treatment effect, shorter reaction time, higher reaction efficiency, greater degradation rate of COD and better effects for chromaticity and odor than the treatment method with ozone alone does.

For example, the tilted-plate catalytic tower 9 is connected with the first catalytic reactor 5 and a Virtue & Clean integrated waste-clean water machine for treating printing and dyeing wastewater. After treatment for 30 min, the decoloration effect is obvious, suspended particles are decreased and the COD is reduced from 1860 mg/L to 867 mg/L and the degradation rate reaches 53.4%. See Table 6 for details:

TABLE 6

| Water Quality | | After Treatment | Degradation |
|---|---|---|---|
| Parameter | Original Sample | for 3 h | Rate |
| COD (mg/L) | 1860 | 867 | 53.4% |
| Chromaticity | Dark brown | Light yellow | — |
| Suspended particles | More | Few | — |

### Embodiment 7

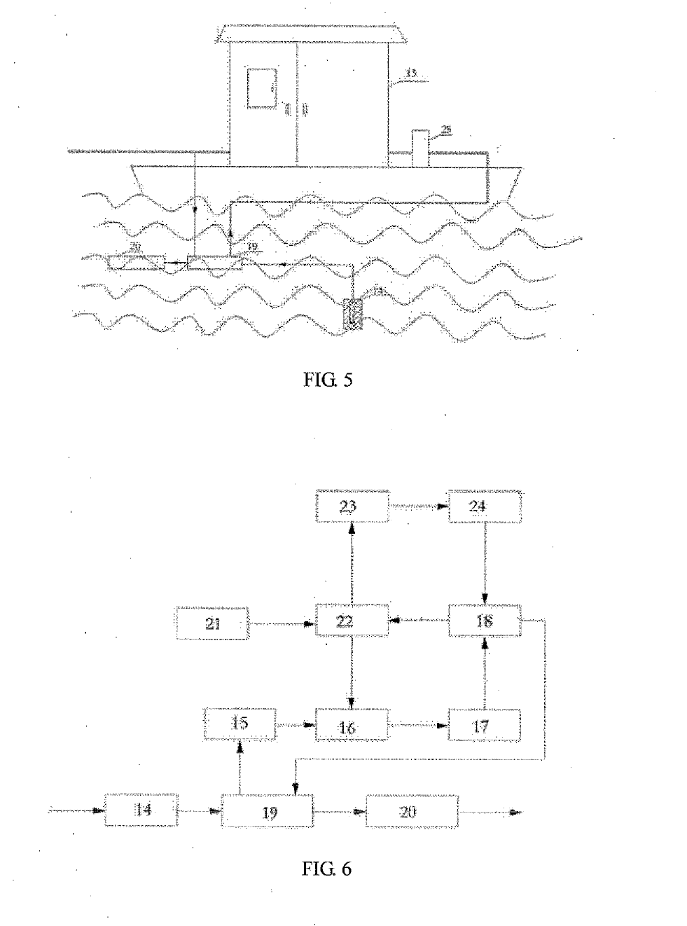

As shown in FIG. 5 and FIG. 6, a wastewater treatment system according to the present invention, comprising a submersible pump 14, a filtering mixer 19, a second Venturi mixer 16, an ozone generating unit, a second catalytic reactor 17, a second heat exchanger 18 and a revolving mixer 20; the number and the diameter of the second catalytic reactor 17 is one and 100 mm respectively, the capacity of the second ozone generator 22 is 50 g/h, and the ozone generating unit comprises a second oxygen generator 21 and a second ozone generator 22. The submersible pump 14, the second centrifugal pump 15, the second oxygen generator 21, the second ozone generator 22, the second Venturi mixer 16 and the second catalytic reactor 17 are installed together in a second enclosure 13, and one second enclosure 13 is provided.

The filtering mixer 19, the second Venturi mixer 16, the second oxygen generator 21, the second ozone generator 22, the second catalytic reactor 17, the second heat exchanger 18 and the revolving mixer 20 are all provided with inlets and outlets; the first outlet of the submersible pump 14 is connected with the first inlet of the filtering mixer 19 by a pipe; the wastewater pumped by the submersible pump 14 enters the filtering mixer 19 which has the function of divergence through its inlet, 10 m³ enters the second catalytic reactor 17 and the rest (20 m³) flows through the straight pipe of the filter mesh of the filtering mixer 19 and stays in the filtering mixer 19; after revolving twice in the revolving mixer 20, the 20 m³ of water is discharged into waters where it mixes with untreated water therein, wherein revolving can increase the area which is affected by the 20 m³ of water in the waters. The water enters the waters at a high rate, so it will cause the waters to flow and expand the area that will be affected. During operation, the gases in the water body will accumulate within the upper of the drum. The gases will be forced into the water body due to the limitation of space, and no waste will be caused. A revolving mixer 20 is connected at the second outlet of the filtering mixer 19 to revolve and mix the wastewater that has been treated but still contains residual ozone with the wastewater in the nearby waters; after treatment by revolving, the flow of the wastewater treatment system according to the present invention that affects the waters is 30 m³/h. In such a way, ozone is efficiently diffused into nearby waters, significantly increasing the wastewater treatment capacity, improving the utilization rate of ozone, and reducing energy consumption and operation cost.

The first outlet of the second ozone generator 22 is connected with the second inlet of the second Venturi mixer 16 by a pipe; the outlet of the second Venturi mixer 16 is connected with the inlet of the second catalytic reactor 17 by a pipe; the outlet of the second catalytic reactor 17 is connected with the first inlet of the second heat exchanger 18 by a pipe; the wastewater in the second catalytic reactor 17 enters the second heat exchanger 18 to cool the cooling water because the cooling water is heated in cooling the second ozone generator 22 and it must be cooled before cycling.

The first outlet of the second heat exchanger 18 is connected with the second inlet of the filtering mixer 19 by a pipe, so that the wastewater that has been treated in the second catalytic reactor 17 enters the filtering mixer 19 where it mixes with the 20 m³ of wastewater that does not enter the second catalytic reactor 17;

the wastewater treatment system also comprises a centrifugal pump arranged between the filtering mixer 19 and the second Venturi mixer 16; the second centrifugal pump 15 is provided with an inlet and an outlet; the first outlet of the filtering mixer 19 is connected with the inlet of the second centrifugal pump 15 by a pipe; the outlet of the second centrifugal pump 15 is connected with the first inlet of the second Venturi mixer 16; the inner surface of the second catalytic reactor 17, the inner and outer surfaces of the internal parts of the second catalytic reactor 17, the inner surface of the second heat exchanger 18, the inner and outer surfaces of the internal parts of the second heat exchanger, and inner surface of the pipes are all applied with noble metal catalyst coating, increasing the reaction rate of the ozone catalytic oxidation.

A second oxygen generator 21 and a second ozone generator 22 are provided within the ozone generating unit and connected by a pipe; the outlet of the second oxygen generator 21 is connected with the first inlet of the second ozone generator 22 by a pipe; the first outlet of the second ozone generator 22 is connected with the second inlet of the second Venturi mixer 16 by a pipe;

the second outlet of the second heat exchanger 18 is connected with the second inlet of the second ozone generator 22 by a pipe; the second outlet of the second ozone generator 22 is connected with the inlet of the cooling water tank 23 by a pipe; the outlet of the cooling water tank 23 is connected with the inlet of the second circulating pump 24 by a pipe; the outlet of the second circulating pump 24 is connected with the second inlet of the second heat exchanger 18 by a pipe;

the second ozone generator 22, the cooling water tank 23, the second circulating pump 24 and the second heat exchanger 18 form a cooling water circulating system. The flows of the second circulating pump, the filtering mixer 19 and the revolving mixer 20 are 0.5 m³/h, 30 m³/h and 30 m³/h respectively. The filtering mixer 19 is submerged in the water and the revolving mixer 20 suspends in the water.

The wastewater treatment system according to the present invention can be placed on a platform floating on the water and permanently connected with an integrated catalytic oxidation water treatment equipment by means of bolts into a whole body, and it can also placed on the bank of a wastewater pool for mobile treatment. In addition, a precision filter mesh 25 is provided between the filtering mixer 19 and the second heat exchanger 18.

The second circulating pump 24 is used to drive the re-circulating water and form a heat exchange cycle which transmits the heat generated by the ozone generating unit to the treated water through the second heat exchanger 18, and the water carries away the heat, saving a great quantity of cooling water or energy consumed in cooling the ozone generating unit; besides, the surface of the second heat exchanger 18 is applied with catalytic materials to catalyze the ozone oxidation of the wastewater and increase the reaction rate.

The inside of the revolving mixer 20 is applied with a catalyst coating carried on the granular porous ceramic surface, increasing the reaction rate of ozone catalytic oxidation to a large extent. The second ozone generator 22 is provided with a cooling room; the number of the second catalytic reactor 17 is one or more, and these second catalytic reactors 17 are connected in series or in parallel by a pipe.

The second inlet of the filtering mixer 19 is provided with a filter mesh to remove foreign bodies in the wastewater entering the second catalytic reactor 17, while the wastewater not entering the second catalytic reactor 17 flows along the filter mesh directly and washes away the foreign bodies on the surface of the filter, achieving the effect of cleaning the filter. The wastewater that has been treated in the second catalytic reactor 17 by catalytic oxidation enters the filtering mixer 19 where it mixes and reacts with the wastewater that does not enter the second catalytic reactor 17. A gas flowmeter is provided on the pipe for connecting the ozone generating unit and the second catalytic reactor 17.

The retention time of the mixture in the second catalytic reactor 17 is 10 s-500 s; the ozone intake of the second Venturi mixer 16 is regulated by the flow of the second centrifugal pump and the valve on the pipe.

The second outlet of the filtering mixer 19 is connected with the inlet of the revolving mixer 20 by a pipe. After revolving twice in the revolving mixer 20, the water is discharged into waters where it mixes with untreated water therein, wherein revolving can increase the area, which is affected by the water in the waters. The water enters the waters at a high rate, so it will cause the waters to flow and expand the area that will be affected. During operation, the gases in the water body will accumulate within the upper of the drum. The gases will be forced into the water body due to the limitation of space, and no waste will be caused. A revolving mixer 20 is connected at the second outlet of the filtering mixer 19 to revolve and mix the wastewater that has been treated but still contains residual ozone with the wastewater in the nearby waters; after treatment by revolving, the flow of the wastewater treatment system according to the present invention that affects the waters is 30 m³/h. In such a way, ozone is efficiently diffused into nearby waters, significantly increasing the wastewater treatment capacity, improving the utilization rate of ozone, and reducing energy consumption and operation cost.

The wastewater treatment method applied in the wastewater treatment system according to the present invention includes the following steps:

(1) conduct pretreatment, absorption and precipitation for the wastewater;

(2) allow the wastewater to enter the filtering mixer 19 which has the function of divergence through the submersible pump 14;

(3) some wastewater enters the centrifugal pump from the outlet of the filtering mixer 19 and the rest remains in the filtering mixer 19 after divergence by the filtering mixer 19; the filtering mixer 19 has the functions of filtering and self-cleaning and a filter mesh element that does not need replacement, and it can remove foreign bodies in the wastewater efficiently to prevent pipes from being blocked. The untreated wastewater in the filtering mixer 19 mixes with the wastewater that has been treated but still contains residual ozone to make full use of the ozone that is not completely consumed in the reaction, greatly improving the utilization rate of ozone and the wastewater treatment capability;

(4) the wastewater is transported to the second Venturi mixer 16 through the second centrifugal pump 15 at a certain speed, and the second Venturi mixer 16 produces negative pressure to take in the ozone produced by the ozone generating unit and form the mixture of the ozone and the wastewater;

(5) the mixture enters the second catalytic reactor through pipes, fully contacts the catalyst coating in the second catalytic reactor 17 and undergoes an oxidation-reduction reaction under the catalysis of the catalyst;

(6) the second ozone generator 22, the cooling water tank 23, the second circulating pump 24, and the second heat exchanger 18 form a cooling water circulating system to reduce the temperature of the second ozone generator 22; the wastewater exchanges heat with the cooling water that has been used to cool the second ozone generator 22 in the heat exchanger 18 to reduce the temperature of the cooling water; the second heat exchanger 18 transports the wastewater to the filtering mixer 19, and the ozone remaining in the reaction mixes with the wastewater that does not enter the second catalytic reactor 17;

(7) some wastewater that has been treated but still contains ozone enters the revolving mixer 20 from the filtering mixer 19; after revolving twice in the revolving mixer 20, the water is discharged through the outlet of the revolving mixer 20 into waters where it mixes with untreated water therein; revolving can increase the area which is affected by the water in the waters, causing residual ozone to be consumed.

A PLC intelligence programmed monitoring and control system is adopted in the wastewater treatment system according to the present invention to conduct automatic monitoring, alarm and protection for many parameters such as water temperature, water flow, electrical parameters and gas flow so as to ensure that the safe and normal operation of the system is automatically controlled by preset programs and realize remote centralized control for easy management based on customers' needs.

The wastewater treatment system according to the present invention, easy to install and use, can improve the wastewater treatment capacity and the utilization rate of ozone and filter mesh foreign bodies in the surface water effectively to prevent pipes from being blocked. This wastewater treatment system not only can disinfect surface water and rainwater, but also can treat industrial re-circulating water and the wastewater that has been treated by factories but is not up to standard. The present invention has the following advantages:

(1) The filtering mixer 19 provided at the inlet of the equipment has the functions of filtering and self-cleaning and a filter mesh element that does not need replacement, and it can remove foreign bodies in the wastewater efficiently to prevent pipes from being blocked. The untreated wastewater at the outlet of the filtering mixer 19 mixes with the wastewater that has been treated but still contains residual ozone to make full use of the ozone that is not completely consumed in the reaction, greatly improving the utilization rate of ozone and the wastewater treatment capability.

(2) A revolving mixer 20 is connected at the outlet of the filtering mixer 19 to mix the wastewater that has been treated but still contains residual ozone with the wastewater nearby by revolving so as to diffuse the ozone into nearby waters efficiently, improving the wastewater treatment capability and the utilization rate of ozone to a large extent, reducing energy consumption and eventually reducing operation cost.

(3) The ozone surface water treatment equipment is an automatic integrated one, easy to operate, i.e. the equipment can be placed on the bank or on a platform which can float on the water surface freely to realize quick control of wastewater.

(4) The inside of the second catalytic reactor 17, the second heat exchanger 18 and the pipes according to the present invention are all applied with noble metal catalyst coating for enhancing the capacity of the ozone to oxide wastewater, and additionally, a catalyst coating carried on the granular porous ceramic surface can be added in the revolving mixer 20 to increase the reaction rate of ozone catalytic oxidation to a large extent.

(5) It can degrade surfactants and other polymeric organic matter in the surface water efficiently, reduce the total level of phosphorus and ammonia nitrogen in water bodies, and quickly eliminate algae and fungus matter to make the water bodies nontoxic and harmless, so as to solve environmental pollution problems at the root and realize zero-pollutant and environmentally-friendly discharge.

### Embodiment 8

The difference between Embodiment 8 and Embodiment 7 lies in that: The wastewater treatment system in the embodiment comprises four second catalytic reactors 17 with a diameter of 150 mm, one ozone generating unit with an ozone generating capacity of 60 g/h, and one 5 m³/h second circulating pump 24. The outlet of the submersible pump 14 is connected with the filtering mixer 19 with a flow of 30 m³/h, and the second outlet of the filtering mixer 19 is connected with the revolving mixer 20 with a flow of 50 m³/h, then after revolving treatment by the revolving mixer 20, the flow of the wastewater treatment system that affects the waters is 50 m³/h.

### Embodiment 9

The difference between Embodiment 9 and Embodiment 7 lies in that: The wastewater treatment system in the embodiment comprises four second catalytic reactors 17 with a diameter of 200 mm, three ozone generating unit with an ozone generating capacity of 60 g/h, and one 12 m³/h second circulating pump 24. The outlet of the submersible pump 14 is connected with the filtering mixer 19 with a flow of 50 m³/h, and the outlet of the filtering mixer 19 is connected with a revolving mixer 20 with a flow of 50 m³/h. The inlet of the filtering mixer 19 is connected with a submersible pump 14 with a flow of 50 m³/h so that the wastewater pumped by the submersible pump 14 enters the filtering mixer 19 which has the function of divergence through its first inlet, 20 m³ enters the second catalytic reactor 17 and the rest (30 m³) stays in the filtering mixer 19; the wastewater that has been treated in the second catalytic reactor 17 enters the filtering mixer 19 where it mixes and reacts with the 30 m³ of wastewater that does not enter the second catalytic reactor 17; after revolving treatment by the revolving mixer 20, the flow of the wastewater treatment system that affects the waters is 50 m³/h.

The above describes and illustrates the basic principles, main features and advantages of the present invention. It would be obvious to those skilled in the field that the present invention is not limited by the embodiments above, the embodiments and the descriptions in the specification are only intended for elucidating the principles of the present invention, the present invention may have many changes and modifications without departure from the spirit and scope of the present invention, and the protection scope claimed for the present invention is defined by the claims attached, the specification and the equivalents thereof.

1. A wastewater treatment system, characterized in that the wastewater treatment system comprises a wastewater pump, a tilted-plate catalytic tower, a first centrifugal pump, a first injector, a first oxygen generator, a first ozone generator, a first catalytic reactor, a first heat exchanger, a packed tower, an aeration biological tower and a water storage tank;
wherein the wastewater pump, the tilted-plate catalytic tower, the first injector, the first oxygen generator, the first ozone generator, the first catalytic reactor, the first heat exchanger, the packed catalytic tower, the aeration biological tower and the water storage tank are all provided with inlets and outlets;
wherein the outlet of the wastewater pump is connected with the first inlet of the tilted-plate catalytic tower by a pipe; the first outlet of the tilted-plate catalytic tower is connected with the inlet of the first centrifugal pump by a pipe; the outlet of the first centrifugal pump is connected with the first inlet of the first injector by a pipe;
wherein the outlet of the first oxygen generator is connected with the inlet of the first ozone generator by a pipe; the output of the first ozone generator is connected with the second inlet of the first injector by a pipe; the outlet of the first injector is connected with the inlet of the first catalytic reactor by a pipe; the outlet of the first catalytic reactor is connected with the inlet of the first heat exchanger by a pipe; the outlet of the first heat exchanger is connected with the second inlet of the tilted-plate catalytic tower by a pipe, the second outlet of the tilted-plate catalytic tower is connected with the inlet of the packed catalytic tower by a pipe, and the outlet of the aeration biological tower is connected with the inlet of the water storage tank by a pipe.

2. The wastewater treatment system according to claim 1, characterized in that the outlet of the water storage tank is provided with a sampling opening; the first oxygen generator is a molecular-sieve first oxygen generator; and the first injector is a first Venturi mixer;
wherein the wastewater treatment system also comprises a cooling system, which comprises a cooling water tank, a first circulating pump, a first heat exchanger and a first ozone generator connected by pipes to form a cooling water circulating loop; a side of the first heat exchanger that contacts wastewater is coated with a catalyst coating to facilitate catalytic oxidation of wastewater;
wherein the wastewater treatment system also comprises an air blower, an outlet of which is connected with a second inlet of the aeration biological tower by a pipe; the wastewater treatment system also comprises a filter and a deflector to change an incoming direction of an ozone-containing water and to enlarge the surface area of the ozone-containing water;
wherein the first outlet of the tilted-plate catalytic tower is provided with a filter, the deflector is arranged between the first ozone generator and the first Venturi mixer; the ozone intake of the first Venturi mixer is regulated by a flow of the first centrifugal pump and the valve on the pipe;
wherein the wastewater pump is a submersible pump or a centrifugal wastewater pump; a pipe connecting the wastewater pump and the tilted-plate catalytic tower is provided with a pressure controller and a flow controller.

3. The wastewater treatment system according to claim 1, characterized in that the first oxygen generator is provided with an air compressor, the second inlet of the aeration biological tower is connected with the second outlet of the first oxygen generator by a pipe, the first outlet of the first oxygen generator is connected with the inlet of the first ozone generator by a pipe; an aeration network and an aeration tray are provided at the second inlet of the aeration biological tower, which contains porous packings; in the packed catalytic tower are provided with particle packings of inertia noble metal powders, a specific surface area of which is 0.1-100 m²/g; in the aeration biological tower are provided with multiple layers of tilted folded plates, whose projections overlap, and an angle between each layer of the folded plates and the central axis of the tower body is 30-89°.

4. The wastewater treatment system according to claim 3, characterized in that the first heat exchanger is a plate-type heat exchanger or a shell-and-tube heat exchanger; the projection length of the folded plates of the aeration biological tower exceeds the length of the central axis of the tower body by 5-500 mm; a retention time of the mixture in the wastewater treatment system is longer than 10 s; the wastewater pump, the tilted-plate catalytic tower, the first centrifugal pump, the first Venturi mixer, the first oxygen generator, the first ozone generator, the second catalytic reactor, the first heat exchanger, the packed catalytic tower, the aeration biological tower, the air compressor and the water storage tank are integrated in one or more first enclosures, connected in series by one or more pipes.

5. The wastewater treatment system according to claim 1, characterized in that the wastewater treatment system is configured to perform a method comprising the following steps:
(1) processing a wastewater with pretreatment, absorption and precipitation; then introducing the wastewater through the wastewater pump into the tilted-plate catalytic tower, which functions as a diverter; by diversion in the tilted-plate catalytic tower, some wastewater enters the first centrifugal pump from the first outlet of the tilted-plate catalytic tower, while the rest of the wastewater remains in the tilted-plate catalytic tower;
(2) introducing the wastewater into the first Venturi mixer through the pump at a certain speed, and the first Venturi mixer produces negative pressure to draw in the ozone produced by the first ozone generator and form the mixture of the ozone and the wastewater;
(3) introducing the mixture in the first Venturi mixer into the second catalytic reactor through pipes, and then fully contacts the catalyst coating in the second catalytic reactor before undergoing an oxidation-reduction reaction under the catalysis of the catalyst;
(4) introducing the products of the oxidation-reduction reaction though the first heat exchanger into the tilted-plate catalytic tower, while mixing the ozone and the oxygen remaining in the reaction with the wastewater that does not enter the second catalytic reactor;
(5) introducing the reaction products into the packed catalytic tower through the second outlet of the tilted-plate catalytic power, while the remaining ozone and oxygen undergoing a full oxidation-reduction reaction with the wastewater;
(6) introducing the reaction products into the aeration biological tower through the outlet of the packed catalytic tower; after treatment in the aeration biological tower, the water flows into the water storage tank, the outlet of which is provided with a sampling opening for the purpose of sampling and testing.

6. A tilted-plate catalytic tower for a wastewater treatment system, characterized in that the tilted-plate catalytic tower comprises a first base, on which a body of a tilted-plate catalytic tower is provided; the body of the tilted-plate catalytic tower, from bottom to top, consists of a first tower bottom, a first packing layer and a first tower top; the first tower bottom is provided with an end cover at the bottom, along with an ozone-containing water inlet and a wastewater inlet on the side walls, and the end cover of the tower bottom is attached with a first emptying valve; the packing layer is filled with catalyst solid packings; the first tower top is provided with an end cover, and a wastewater outlet on side wall; a divergence wastewater outlet is provided below the wastewater inlet on the side wall of the first tower bottom.

7. The tilted-plate catalytic tower according to claim 6, characterized in that the divergence wastewater outlet is provided with a filter mesh made of stainless steel; the end of the L-shaped wastewater inlet is connected with a trumpet mouth facing downward and just opposite to the filter mesh; the end covers of the first tower bottom and the first tower top are arc-shaped; the body of the tilted-plate catalytic tower is made of stainless steel; the ozone-containing water inlet, L-shaped, is provided with a reflector; in the first packing layer are provided packing support plates, on which solid packings are loaded in form of folded plates and tilted plates with rough surfaces where applied inert noble metal catalyst, and the included angle between horizontal plane and the folded plates or tilted-plates is 80-90°; the packing layer is filled with the solid packings, which are arranged in multiple layers; the wastewater outlet is connected with a T-adaptor and provided with a sampling opening.

8. (canceled)

9. (canceled)

10. A wastewater treatment system, characterized in that the wastewater treatment system comprises a pump, a filtering mixer, a second injector, an ozone generating unit, a reactor, a second heat exchanger and a revolving mixer;
the filtering mixer, the second injector, the ozone generating unit, the second reactor, the second heat exchanger and the revolving mixer are all provided with inlets and outlets; the first outlet of the pump is connected with the first inlet of the filtering mixer by a pipe; the first outlet of the filtering mixer is connected with the first inlet of the second injector by a pipe;
the first outlet of the ozone generating unit is connected with the second inlet of the second injector by a pipe; the outlet of the second injector is connected with the inlet of the reactor by a pipe; the outlet of the reactor is connected with the first inlet of the second heat exchanger by a pipe; the first outlet of the second heat exchanger is connected with the second inlet of the filtering mixer by a pipe, and the second outlet of the filtering mixer is connected with the inlet of the revolving mixer by a pipe.

11. The wastewater treatment system according to claim 10, characterized in that the pump is a submersible pump; the wastewater treatment system also comprises a second centrifugal pump arranged between the filtering mixer and the second injector; the second centrifugal pump is provided with an inlet and an outlet; the first outlet of the filtering mixer is connected with the inlet of the second centrifugal pump by a pipe; the outlet of the second centrifugal pump is connected with the first inlet of the second injector by a pipe; the inner surface of the reactor, the inner and outer surfaces of the internal parts of the reactor, the inner surface of the second heat exchanger, the inner and outer surfaces of the internal parts of the second heat exchanger, and inner surface of the pipes are all applied with noble metal catalyst coating.

12. The wastewater treatment system according to claim 11, characterized in that the reactor is a second catalytic reactor; a second oxygen generator and a second ozone generator are provided within the ozone generating unit and connected by a pipe; the outlet of the second oxygen generator is connected with the first inlet of the second ozone generator by a pipe; the first outlet of the second ozone generator is connected with the second inlet of the second injector by a pipe;
the second outlet of the second heat exchanger is connected with the second inlet of the second ozone generator by a pipe; the second outlet of the second ozone generator is connected with the inlet of the cooling water tank by a pipe; the outlet of the cooling water tank is connected with the inlet of the second circulating pump by a pipe; the outlet of the second circulating pump is connected with the second inlet of the second heat exchanger by a pipe; the second ozone generator, the cooling water tank, the second circulating pump and the second heat exchanger form a cooling water circulating system; the inside of the revolving mixer is applied with a catalyst coating carried on the granular porous ceramic surface; the second ozone generator is provided with a cooling chamber; the second injector is a second Venturi mixer; and one or more than one second catalytic reactor is provided and connected in series by a pipe.

13. The wastewater treatment system according to claim 12, characterized in that the submersible pump, the second centrifugal pump, the ozone generating unit, the second injector and the second catalytic reactor are installed together in a second enclosure, and one or more than one second enclosures is provided and connected in series by a pipe; the second inlet of the filtering mixer is provided with a filter; a gas flowmeter is provided on the pipe for connecting the ozone generating unit and the second catalytic reactor; the retention time of the mixture in the second catalytic reactor is 10 s-500 s.

14. The wastewater treatment system according to claim 10, characterized in that the wastewater treatment system is configured to perform a method comprising the following steps:
(1) performing pretreatment, absorption and precipitation of wastewater;
(2) allowing the wastewater to enter a filtering mixer, which functions as a diverter, through the submersible pump;
(3) diverting some wastewater into the second centrifugal pump from the outlet of the filtering mixer and the rest of the wastewater remains in the filtering mixer after divergence by the filtering mixer;
(4) introducing the wastewater into the second injector through the second centrifugal pump at a certain speed, and the second injector produces negative pressure to take in the ozone produced by the ozone generating unit and form the mixture of the ozone and the wastewater;
(5) introducing the mixture into the second catalytic reactor through pipes, fully contacts the catalyst coating in the second catalytic reactor and undergoes an oxidation-reduction reaction under the catalysis of the catalyst;
(6) connecting the second ozone generator, the cooling water tank, the second circulating pump, and the second heat exchanger to form a cooling water circulating system to reduce the temperature of the second ozone generator; the wastewater exchanges heat with the cooling water that has been used to cool the second ozone generator in the heat exchanger to reduce the temperature of the cooling water; the second heat exchanger transports the wastewater to the filtering mixer, and the ozone remaining in the reaction mixes with the wastewater that does not enter the second catalytic tower;
(7) introducing some wastewater that has been treated but still contains ozone into the revolving mixer from the filtering mixer, is revolving twice in the revolving mixer and then discharged through the outlet of the revolving mixer to the waters in which it mixes with the untreated water therein to consume the remaining ozone.
